(19) United States
(12) Patent Application Publication
(10) Pub. No.: US 2016/0213570 A1
(43) Pub. Date: Jul. 28, 2016

(54) Oral administration device

(71) Applicant: Jeanette Cathrine Marie Wales Athanassiou, Mississauga (CA)

(72) Inventor: Jeanette Cathrine Marie Wales Athanassiou, Mississauga (CA)

(21) Appl. No.: 14/544,605

(22) Filed: Jan. 27, 2015

(51) Int. Cl. A61J 7/00

(52) U.S. Cl. CPC A61J 7/0053

(57) ABSTRACT

A product administering device having a barrel of smooth regular cylindrical shape along its length, open at both ends, and nipple attachable to one end of the barrel, a cheek plate at the one end of the barrel, a plunger having a flexible head insertable into the barrel from its other end, finger plates attached to the barrel, and a plunger stem of planar synthetic material connected to the plunger head, the edges of the planar material fitting within the barrel to act as a guide for movement of the plunger into and out of the barrel.

### FIELD OF THE INVENTION

The invention relates to an administration device for infants, which provides for administration of a product, or medication, to the infant through a nipple.

### BACKGROUND OF THE INVENTION

The use of a simple pacifier to sooth an infant is common place. Such simple devices usually incorporate a nipple, and a cheek plate.

Numerous proposals have been made for variations on this simple design. Toys or simple music players may be combined with the device.

Various proposals are suggested for administering some product, usually a liquid product, or for example a medication of some kind, through the nipple so that the infant will receive the product, without the fuss of attempting to deliver it by, for example, a spoon.

Such proposals have been either complex and costly to make, eg U.S. Pat. No. 6,110,193, or excessively simple, and not adequate for the purpose.

Low cost is one important factor. Safety is another. Ease of use is another. And of course any such device must be capable of being taken apart for sterilisation, usually by boiling, on a daily basis.

### BRIEF SUMMARY OF THE INVENTION

With a view to meeting these conflicting factors, the invention provides a product administering device having a barrel of smooth regular cylindrical shape along its length, and a nipple attachable to one end of the barrel, the other end being open, a cheek plate at the one end of the barrel, a plunger having a flexible plunger head insertable into the open end of the barrel from its other end, finger plates attached to the barrel, and a plunger stem of planar synthetic material connected to the plunger head, the edges of the plunger stem planar material fitting within the barrel to act as a guide for movement of the plunger into and out of the barrel.

Preferably the plunger stem consists of planar strips of material having a cruciform section.

Preferably the plunger stem has a finger button for ease of operation. The nipple is removably attached by a ring and flange.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1 is a perspective view illustrating the invention in the form of a liquid administrator device;

FIG. 2 is a exploded perspective showing the various parts; and,

FIG. 3 is a perspective of a portion of the device.

### DESCRIPTION OF A SPECIFIC EMBODIMENT

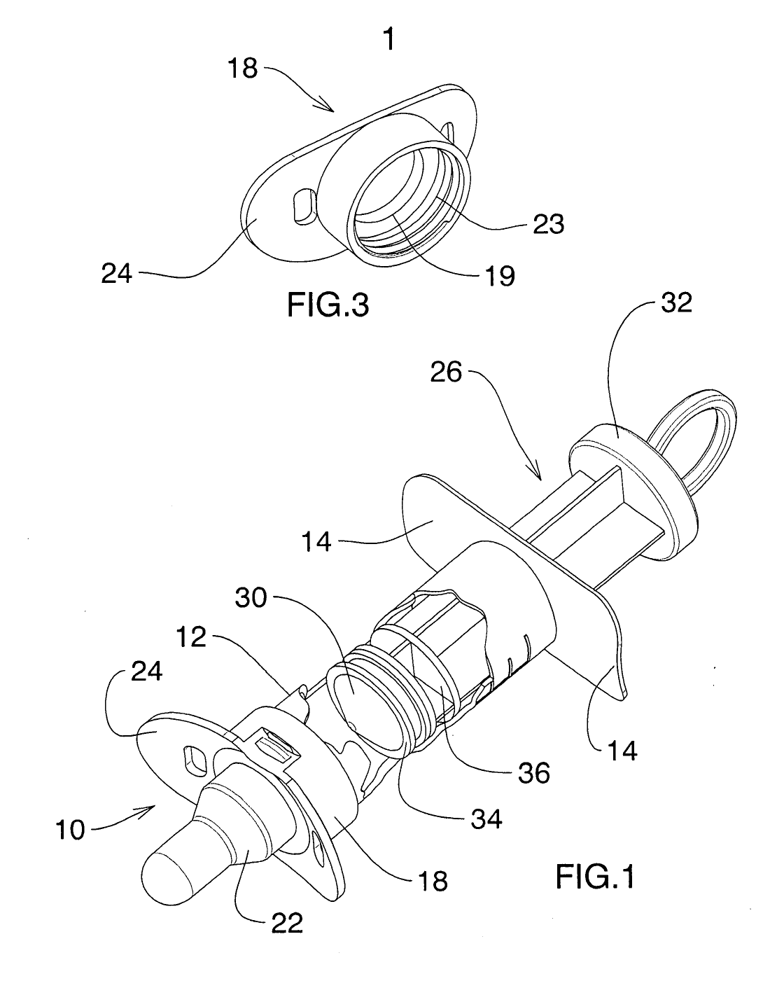

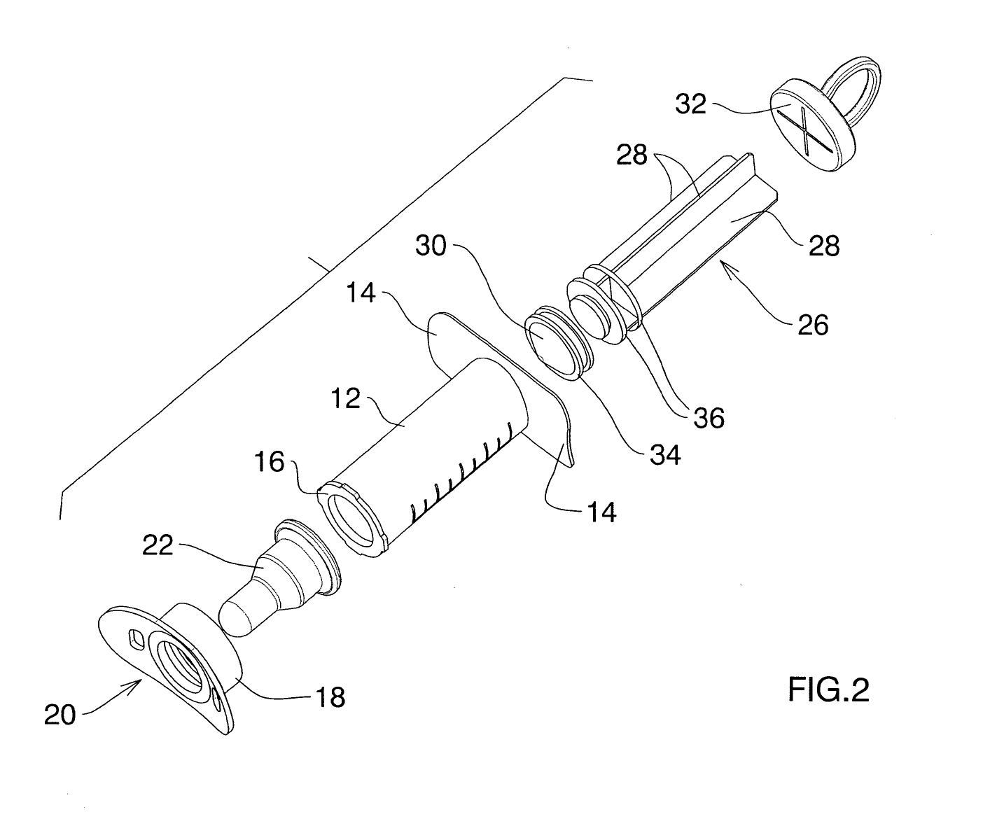

Referring first to FIGS. 1 and 2, it will be seen that the invention is illustrated in the form of an administration device (10). The device (10) is designed to enable the administration of a liquid product, whether a food, a supplement, or a medication of some kind, to the infant.

The device (10) has a barrel (12) which is of regular cylindrical shape along its interior, and is open at both ends.

At a first end finger plates (14) are formed, extending to each side, providing the usual function of a syringe, enabling it to be controlled by one hand.

At the opposite end of barrel (12) attachment lugs (16) are formed, for reasons described below.

A ring (18) has an annular flange (19) which defines an inner opening (20). A conventional rubber nipple (22) may be fitted through the opening and retained by the flange. Nipple (22) has an opening at its tip. Ring (18) defines interior fastening ridges (23) which engage the lugs (16) on the barrel. This provides a simple rotary lock action, which may be a so called bayonet lock.

Cheek plates (24) are formed on ring (18), similar to a conventional soother, so as to prevent the infant from swallowing the device, and to have the appearance of a soother. In order to provide the administration of a liquid product to the infant, a plunger (26) is provided.

Plunger (26) has a stem which is formed of synthetic material, in this case, with a section consisting of four planar walls (28), arranged in section, in the form of a cross. The walls (28) define outer edges which fit snugly against the interior surface of the cylindrical barrel (12). These wall edges function as guides or spacers which maintain the plunger (26) coaxial with the barrel (12).

Plunger (26) has a piston (30) at one end and a finger button (32) is attached, eg. by adhesive or heat fusion, to the other end.

The piston is typically of synthetic material, (eg silicone material for example) capable of withstanding repeated sterilisation, as by boiling. Piston (30) has a sealing edge (34) which seal on and slide against the interior of the barrel (12).

The stem walls support discs (36). The piston is formed to fit over discs (36) and is replaceable if required.

The barrel may have suitable indicia marked at intervals, to assist in administering the correct dosage.

In use the barrel and nipple and ring are assembled, and the piston (30) withdrawn. A product, typically a liquid product, can then be placed in the barrel. and the piston can then be introduced into the open end of the barrel.

By elevating the device so that the nipple is uppermost, the plunger can then be operated so as to expel air from the barrel.

Holding the device in one hand, the nipple is then offered to the infant in the way of a normal soother. The finger plate is held between two fingers.

Once the infant has taken the nipple, the plunger can then be depressed, ejecting the product in the barrel, through the nipple and into the mouth of the infant. The device is then removed.

The plunger can then be withdrawn from the barrel, and the entire device can easily be taken apart into its separate parts and washed and sterilised on a daily basis.

The foregoing is a description of a preferred embodiment of the invention which is given here by way of example only. The invention is not to be taken as limited to any of the specific features as described, but comprehends all such variations thereof as come within the scope of the appended claims.

What is claimed is:

1. A product administering device for administering a liquid to an infant, the device having the appearance of a soother, and comprising: a barrel of smooth regular cylindrical shape along its length, open at both ends, a nipple attachable to one end of the barrel, a soother-simulator cheek plate at the one end of the barrel, a plunger having a flexible piston head insertable into the barrel from its other end, finger plates attached to the barrel, and a plunger stem of planar synthetic material connected to the piston head, the edges of the planar material of the stem fitting and slidingly engaging within the barrel to act as a guide for movement of the plunger into and out of the barrel, the barrel being adapted to receive the liquid and the piston ejecting the liquid from the nipple,
wherein the plunger and nipple are removable after use, for sterilization.

2. A product administering device as claimed in claim 1 wherein the cheek plate incorporates a retaining ring for holding the nipple on the barrel, and engagement means on the barrel, and on the ring, by which they can be engaged or released from engagement.

3. A product administering device as claimed in claim 2 wherein the plunger stem has four planar strips arranged as a cross, in section.

4. A product administering device as claimed in claim 3 wherein the ring has a flange defining an opening through which the nipple passes, the flange engaging the nipple.

5. A product administering device as claimed in claim 4 including discs attached to said planar strips at one end of said plunger.

6. A product administering device as claimed in claim 5 wherein the piston fits on the discs.

7. A product administering device as claimed in claim 6 including a finger button on the other end of said plunger having slots fitting on said planar walls.

8. A product administering device as claimed in claim 7 including a ring formed on said finger button for withdrawing the plunger from the barrel after use.
